(19) United States
(12) Patent Application Publication
(10) Pub. No.: US 2019/0279636 A1
(43) Pub. Date: Sep. 12, 2019

(54) Context Sensitive Overlays in Voice Controlled Headset Computer Displays

(71) Applicant: Kopin Corporation, Westborough, MA (US)

(72) Inventors: James Woodall, Nottinghamshire (GB); Christopher Parkinson, Richland, WA (US)

(21) Appl. No.: 16/421,360

(22) Filed: May 23, 2019

Related U.S. Application Data
(63) Continuation of application No. 15/993,005, filed on May 30, 2018, now abandoned.
Application No. 15/993,005 is a continuation of application No. 13/799,790, filed on Mar. 13, 2013, now Pat. No. 10,013,976.
Application No. 13/799,790 is a continuation-in-part of application No. 13/234,916, filed on Sep. 16, 2011, now Pat. No. 9,122,307.
Application No. 13/799,790 is a continuation-in-part of application No. 13/799,888, filed on Mar. 13, 2013, now Pat. No. 9,377,862.
(60) Provisional application No. 61/749,240, filed on Jan. 4, 2013.
(60) Provisional application No. 61/384,586, filed on Sep. 20, 2010.
(60) Provisional application No. 61/653,127, filed on May 30, 2012.

(51) Int. Cl. G10L 15/22; G06F 3/01

(52) U.S. Cl. CPC G10L 15/22; G06F 3/017; G06F 3/167; G06F 3/012; G06F 3/011; G06F 3/013

(57) ABSTRACT

In headset computers that leverage voice commands, often the user does not know what voice commands are available. In one embodiment, a method includes providing a user interface in a headset computer and, in response to user utterance of a cue toggle command, displaying at least one cue in the user interface. Each cue can correspond to a voice command associated with code to execute. In response to user utterance of the voice command, the method can also include executing the code associated with the voice command. The user can therefore ascertain what voice commands are available.

### RELATED APPLICATIONS

This application is a continuation of U.S. application Ser. No. 15/993,005 filed May 30, 2018 (Attorney docket no. 0717.2116-013), which is a continuation of U.S. application Ser. No. 13/799,790 filed Mar. 13, 2013, now U.S. Pat. No. 10,013,976 (Attorney docket no. 0717.2116-005), which claims the benefit of U.S. Application No. 61/749,240 filed Jan. 4, 2013 (Attorney docket no. 0717.2116-003) and is a continuation-in-part of U.S. application Ser. No. 13/234,916 filed Sep. 16, 2011, now U.S. Pat. No. 9,122,307 (Attorney docket no. 0717.2116-001), which claims the benefit of 61/384,586 filed Sep. 20, 2010 (Attorney docket no. 0717.2116-000). U.S. application Ser. No. 13/799,790 filed Mar. 13, 2013, now U.S. Pat. No. 9,377,862 (Attorney docket no. 0717.2116-005) also claims priority to and is a continuation-in-part of U.S. application Ser. No. 13/799,888, filed Mar. 13, 2013, now U.S. Pat. No. 9,377,862 (Attorney docket no. 0717.2173-001) which claims the benefit of U.S. Application No. 61/653,127, filed May 30, 2012 (Attorney docket no. 0717.2173-000). The entire teachings of the above applications are incorporated herein by reference.

### BACKGROUND

Mobile computing devices, such as notebook PCs, smart phones, and tablet computing devices, are now common tools used for producing, analyzing, communicating, and consuming data in both business and personal life. Consumers continue to embrace a mobile digital lifestyle as the ease of access to digital information increases with high-speed wireless communications technologies becoming ubiquitous. Popular uses of mobile computing devices include displaying large amounts of high-resolution computer graphics information and video content, often wirelessly streamed to the device. While these devices typically include a display screen, the preferred visual experience of a high-resolution, large format display cannot be easily replicated in such mobile devices because the physical size of such device is limited to promote mobility. Another drawback of the aforementioned device types is that the user interface is hands-dependent, typically requiring a user to enter data or make selections using a keyboard (physical or virtual) or touch-screen display. As a result, consumers are now seeking a hands-free, high-quality, portable, color display solution to augment or replace their hands-dependent mobile devices.

### SUMMARY

Recently developed micro-displays can provide large-format, high-resolution color pictures and streaming video in a very small form factor. One application for such displays can be integrated into a wireless headset computer worn on the head of the user with a display within the field of view of the user, similar in format to either eyeglasses, audio headset or video eyewear. A “wireless computing headset” device includes one or more small high-resolution micro-displays and optics to magnify the image. The WVGA microdisplays can provide super video graphics array (SVGA) (800×600) resolution or extended graphic arrays (XGA) (1024×768) or even higher resolutions. A wireless computing headset contains one or more wireless computing and communication interfaces, enabling data and streaming video capability, and provides greater convenience and mobility through hands dependent devices. For more information concerning such devices, see co-pending patent applications entitled “Mobile Wireless Display Software Platform for Controlling Other Systems and Devices,” U.S. application Ser. No. 12/348, 648 filed Jan. 5, 2009, “Handheld Wireless Display Devices Having High Resolution Display Suitable For Use as a Mobile Internet Device,” PCT International Application No. PCT/US09/38601 filed Mar. 27, 2009, and “Improved Headset Computer,” U.S. Application No. 61/638,419 filed Apr. 25, 2012, each of which are incorporated herein by reference in their entirety.

In one embodiment, a method includes providing a user interface in a headset computer and, in response to user utterance of a cue toggle command, displaying at least one cue in the user interface. Each cue can correspond to a voice command associated with code to execute. In response to user utterance of the voice command, the method can also include executing the code associated with the voice command. In another embodiment, the method can further includes displaying the interface without the cue at least one of prior to the cue toggle command and after a subsequent cue toggle command. Displaying the cue can include displaying words that activate the voice command. Displaying the cue can also include displaying the cue in the user interface corresponding to the voice command associated with the control, where the control is displayed in the user interface. Displaying the cue can include displaying the cue in the user interface corresponding to the voice command associated with the control, where the control is hidden from the user interface. Displaying the cue can include displaying the cue in the user interface corresponding to the voice command associated with the control, where the control is a global headset control. The cue can be loaded from a control, the control indicating the cue and voice command.

In another embodiment, a system for displaying a user interface in a headset computer can include a display module configured to provide a user interface in a headset computer. The display module can be further configured to, in response to user utterance of a cue toggle command, display at least one cue in the user interface. Each cue can correspond to a voice command associated with code to execute. The system can further include a command module configured to, in response to user utterance of the voice command, execute code associated with the voice command.

In another embedment, a method of developing a user interface in a headset computer includes embedding a cue and a voice command in a control for the user interface. The method also includes providing the control to the user interface, the user interface configured to display the cue responsive to a cue toggle command.

### BRIEF DESCRIPTION OF DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A-1B are schematic illustrations of a headset computer cooperating with a host computer (e.g., Smart Phone, laptop, etc.) according to principles of the present invention.

FIG. 2 is a block diagram of flow of data and control in the embodiment of FIGS. 1A-1B.

FIG. 3 is a diagram illustrating an example embodiment of a user interface employed in the HSC.

FIG. 4 is a diagram illustrating an example embodiment of a user interface after receiving a show commands voice command.

FIG. 5 is a flow diagram illustrating an example embodiment of a method employed by the present invention.

FIG. 6 illustrates a computer network or similar digital processing environment in which the present invention may be implemented.

FIG. 7 is a diagram of the internal structure of a computer (e.g., client processor/device or server computers) in the computer system of FIG. 6.

### DETAILED DESCRIPTION

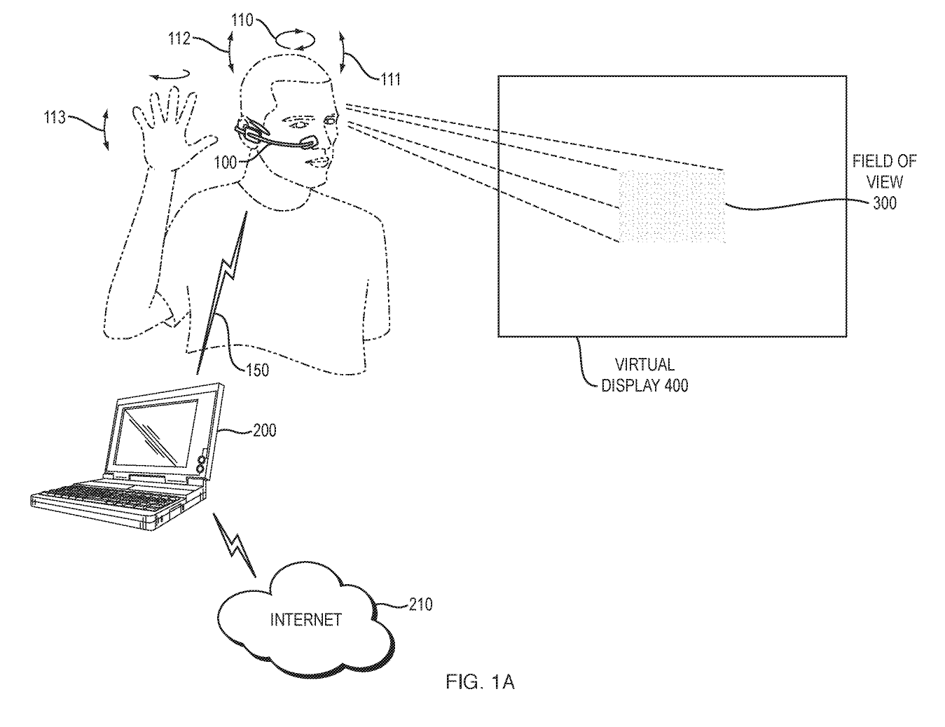

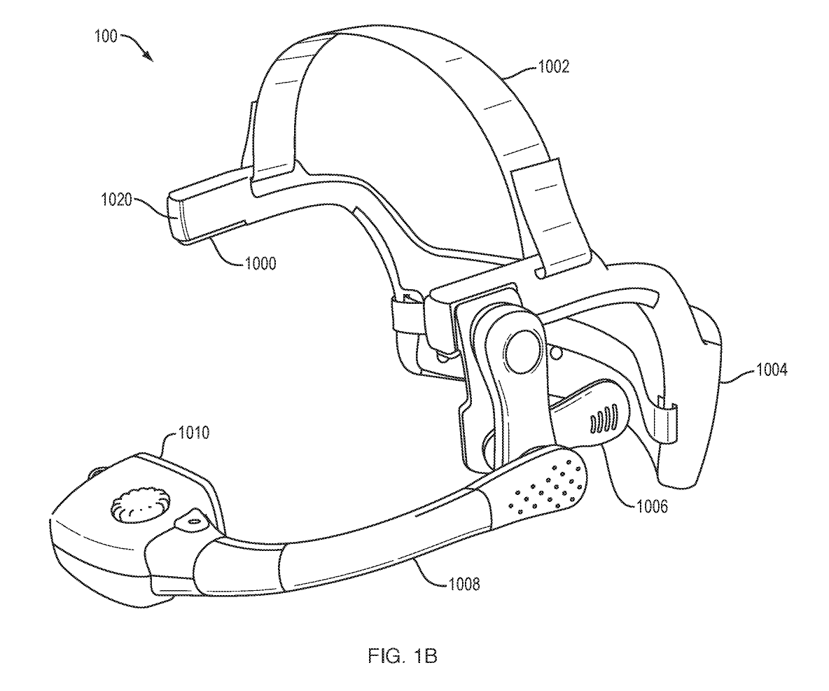

FIGS. 1A and 1B show an example embodiment of a wireless computing headset device 100 (also referred to herein as a headset computer (HSC)) that incorporates a high-resolution (VGA or better) microdisplay element 1010, and other features described below. The HSC 100 can include audio input and/or output devices, including one or more microphones, input and output speakers, geo-positional sensors (GPS), three to nine axis degrees of freedom orientation sensors, atmospheric sensors, health condition sensors, digital compass, pressure sensors, environmental sensors, energy sensors, acceleration sensors, position, attitude, motion, velocity and/or optical sensors, cameras (visible light, infrared, etc.), multiple wireless radios, auxiliary lighting, rangefinders, or the like and/or an array of sensors embedded and/or integrated into the headset and/or attached to the device via one or more peripheral ports (not shown in detail in FIG. 1B). Typically located within the housing of headset computing device 100 are various electronic circuits including, a microcomputer (single or multicore processors), one or more wired and/or wireless communications interfaces, memory or storage devices, various sensors and a peripheral mount or mount, such as a “hot shoe.”

Example embodiments of the HSC 100 can receive user input through sensing voice commands, head movements, 110, 111, 112 and hand gestures 113, or any combination thereof. Microphone(s) operatively coupled or preferably integrated into the HSC 100 can be used to capture speech commands which are then digitized and processed using automatic speech recognition techniques. Gyroscopes, accelerometers, and other micro-electromechanical system sensors can be integrated into the HSC 100 and used to track the user's head movement to provide user input commands. Cameras or other motion tracking sensors can be used to monitor a user's hand gestures for user input commands. Such a user interface overcomes the hands-dependent formats of other mobile devices.

The HSC 100 can be used in various ways. It can be used as a remote display for streaming video signals received from a remote host computing device 200 (shown in FIG. 1A). The host 200 may be, for example, a notebook PC, smart phone, tablet device, or other computing device having less or greater computational complexity than the wireless computing headset device 100, such as cloud-based network resources. The host may be further connected to other networks 210, such as the Internet. The headset computing device 100 and host 200 can wirelessly communicate via one or more wireless protocols, such as Bluetooth®, Wi-Fi, WiMAX, 4G LTE or other wireless radio link 150. (Bluetooth is a registered trademark of Bluetooth Sig, Inc. of 5209 Lake Washington Boulevard, Kirkland, Wash. 98033.) In an example embodiment, the host 200 may be further connected to other networks, such as through a wireless connection to the Internet or other cloud-based network resources, so that the host 200 can act as a wireless relay. Alternatively, some example embodiments of the HSC 100 can wirelessly connect to the Internet and cloud-based network resources without the use of a host wireless relay.

FIG. 1B is a perspective view showing some details of an example embodiment of a headset computer 100. The example embodiment HSC 100 generally includes, a frame 1000, strap 1002, rear housing 1004, speaker 1006, cantilever, or alternatively referred to as an arm or boom 1008 with a built-in microphone, and a micro-display subassembly 1010.

A head worn frame 1000 and strap 1002 are generally configured so that a user can wear the headset computer device 100 on the user's head. A housing 1004 is generally a low profile unit which houses the electronics, such as the microprocessor, memory or other storage device, along with other associated circuitry. Speakers 1006 provide audio output to the user so that the user can hear information. Microdisplay subassembly 1010 is used to render visual information to the user. It is coupled to the arm 1008. The arm 1008 generally provides physical support such that the microdisplay subassembly is able to be positioned within the user's field of view 300 (FIG. 1A), preferably in front of the eye of the user or within its peripheral vision preferably slightly below or above the eye. Arm 1008 also provides the electrical or optical connections between the microdisplay subassembly 1010 and the control circuitry housed within housing unit 1004.

According to aspects that will be explained in more detail below, the HSC display device 100 allows a user to select a field of view 300 within a much larger area defined by a virtual display 400. The user can typically control the position, extent (e.g., X-Y or 3D range), and/or magnification of the field of view 300.

While what is shown in FIG. 1A is a monocular microdisplay presenting a single fixed display element supported on the face of the user with a cantilevered boom, it should be understood that other mechanical configurations for the remote control display device 100 are possible.

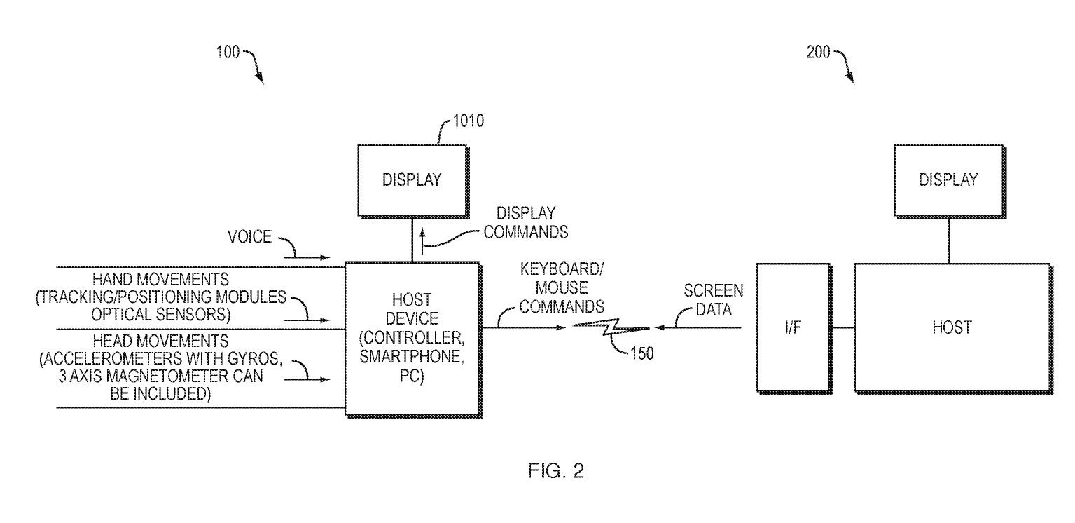

FIG. 2 is a block diagram showing more detail of the HSC device 100, host 200 and the data that travels between them. The HSC device 100 receives vocal input from the user via the microphone, hand movements or body gestures via positional and orientation sensors, the camera or optical sensor(s), and head movement inputs via the head tracking circuitry such as 3 axis to 9 axis degrees of freedom orientational sensing. These are translated by software in the HSC device 100 into keyboard and/or mouse commands that are then sent over the Bluetooth or other wireless interface 150 to the host 200. The host 200 then interprets these translated commands in accordance with its own operating system/application software to perform various functions. Among the commands is one to select a field of view 300 within the virtual display 400 and return that selected screen data to the HSC device 100. Thus, it should be understood that a very large format virtual display area might be associated with application software or an operating system running on the host 200. However, only a portion of that large virtual display area 400 within the field of view 300 is returned to and actually displayed by the micro display 1010 of HSC device 100.

In one embodiment the HSC 100 may take the form of the HSC described in a co-pending US Patent Publication Number 2011/0187640 which is hereby incorporated by reference in its entirety.

In another embodiment, the invention relates to the concept of using a Head Mounted Display (HMD) 1010 in conjunction with an external ‘smart’ device 200 (such as a smartphone or tablet) to provide information and control to the user hands-free. The invention requires transmission of small amounts of data, providing a more reliable data transfer method running in real-time.

In this sense therefore, the amount of data to be transmitted over the connection 150 is small- simple instructions on how to lay out a screen, which text to display, and other stylistic information such as drawing arrows, or the background colors, images to include, etc.

Additional data could be streamed over the same 150 or another connection and displayed on screen 1010, such as a video stream if required by the Host 200.

This invention relates to the viewing of context sensitive overlays within applications, on voice controlled HSCs 100.

The concept is the presentation of data, contextually, over a visual, on demand. Overlays can be called up by the user with a voice command, typically “Show commands.” The voice command is standard across the system 100 and available at all times. This command causes HSC 100 to display applicable voice commands and other information in a context sensitive and intuitive way.

The applicable commands are shown on a semi-transparent overlay of the current screen view of display unit 1010. This allows the user to retain the context of the screen he called the overlay up for.

The overlay and displayed applicable commands fade away after a short period of time. This is accomplished by a timing mechanism that refreshes the screen view.

The applicable commands are displayed in order of relevance. The most relevant command is given more prominence in terms of placement over less relevant commands. 100 determines relevancy based on the current context of the display 1010 contents.

Each screen in the relevant system is made up of user-interface (UI) components, some of which are ‘controls’. A control is a UI component that provides information to the user or enables some form of functionality. Examples of controls are buttons, radio buttons, text boxes, check boxes, drop down menus, file menus, ribbon menus, live tiles, etc. Within the software developer's component library, these are available in their various forms, allowing customization of certain features. For example, one such control might be a ‘button,’ simply enabling the user to press it using a voice command available on the button. Controls, such as the ‘button’ control, are available to the developer, for example, as part of the developer's component library or other library. The developer can insert the pre-coded control and customize it to his or her liking, instead of manually coding the control from scratch.

A “Show Commands” function is built into the controls of the developer library. When the developer, for example, creates a button and specifies a text string to be written onto the button, the text string becomes the default voice command to activate the button, unless the developer (or user) overrides the voice command. The control (e.g., the button) is configured to react to a “show commands” voice command by overlaying the text string to activate the control over the control itself, or near the control.

Every User Interface screen made available on the HSC 100 has the ability to receive a “Show Commands” voice command (e.g., a system command, available by default). Therefore, when a screen is constructed using controls from the UI library, show commands functionality is built in, providing guidance as to the voice commands available to the user. These voice commands are (by default) shown in context of the current displayed contents (screen view).

Other available voice commands can also be placed within the show commands overlay that are not associated with a visible control. These are placed in the overlay by the developer, adding a voice-command only control, or adding a hidden control, and provide a visual cue for voice commands that are not associated with a button or other control.

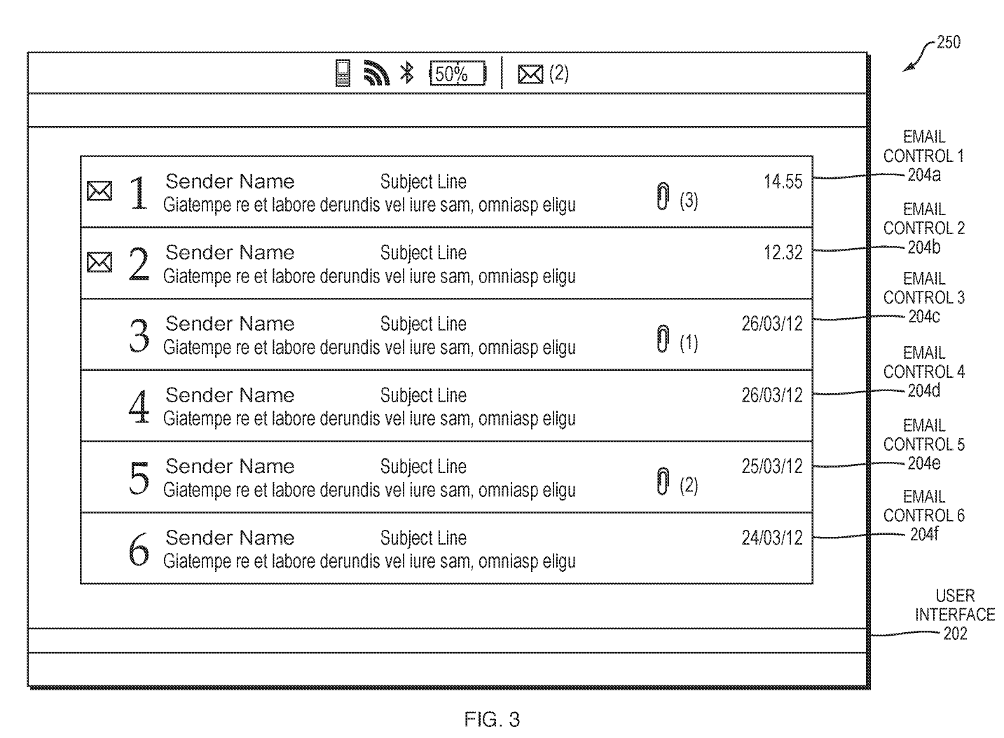

FIG. 3 is a diagram 250 illustrating an example embodiment of a user interface 202 employed in the HSC. The user interface 202, in this embodiment, is an email application displaying a user's inbox. Each email listing is a respective email control 1-6 204a-f. The user can open each email by selecting each control. Each email control 204a-f is programmed to be selected at least by a respective voice command.

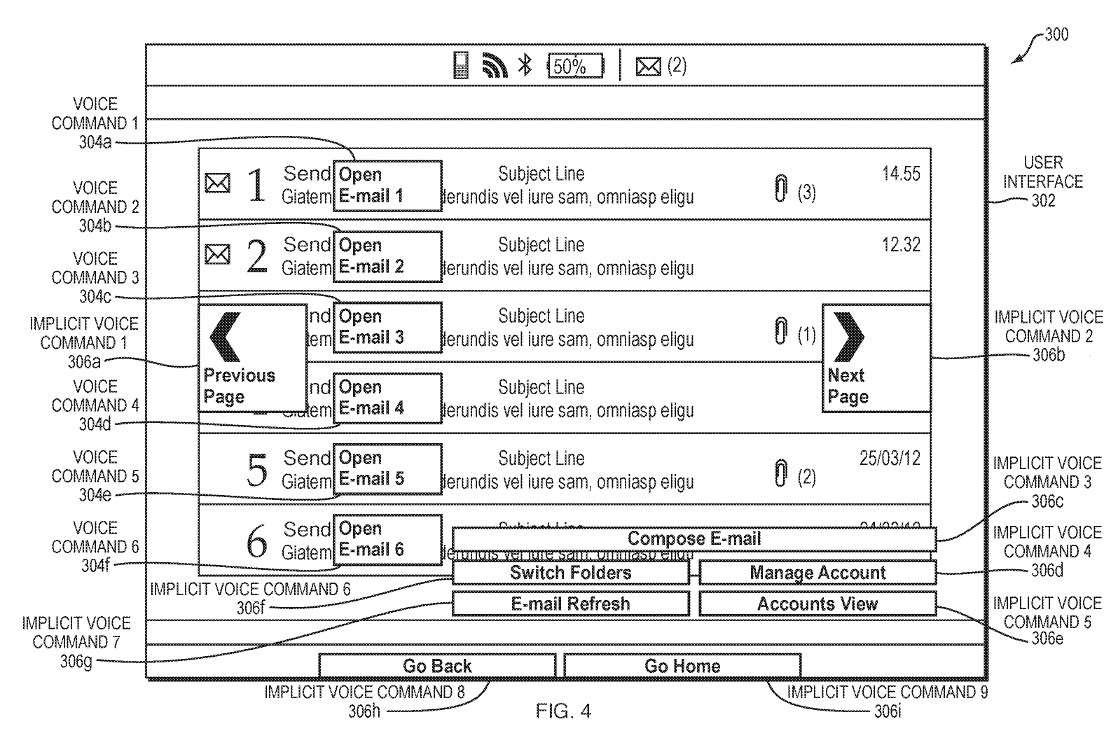

FIG. 4 is a diagram 300 illustrating an example embodiment of a user interface 302 after receiving a show commands voice command. The user interface displays voice commands corresponding to each of the email controls 204a-f of FIG. 2. With respect to FIG. 3, voice commands 1-6 304a-4 correspond with email controls 1-6 204a-f, respectively. For example, saying voice command 1 304a (i.e., “Open E-mail 1”) causes the HSC to open the first email in the list.

The user interface 302 in show commands mode also shows a plurality of implicit voice commands 1-9 306a-i. The implicit voice commands 1-9 306a-i do not correspond to any particular visual control of the user interface, they are voice commands that are available to the user. For example, the user can say implicit voice commands 1 and 2 306a-b to move to the previous and next page, respectively. The user can draft an email by saying implicit command 3 306c. The user can manage his or her email account by saying implicit command 4 306d. The user can see his or her accounts by saying implicit command 5 306e. The user can switch folders by saying implicit voice command 6 306f The user can refresh the inbox by saying implicit voice command 7 306g.

Further, the user can go back to a previous screen by saying implicit voice command 8 306h. The user can return to a home screen by saying implicit voice command 9 306i. Implicit voice commands 8 and 9 can be universal to all screens on the HSC. Voice commands 1-6 304a-f and implicit voice commands 1-7 306a-g are local commands for this particular application. However, in other embodiments, implicit voice commands 1-2 306a-b can be global commands for moving to previous and next pages of applications.

The voice command overlay aids the user by de-cluttering the screen of options and buttons. The voice commands further help prompt the user to how to use the system, which is especially useful while the user is learning how to use the device and voice commands.

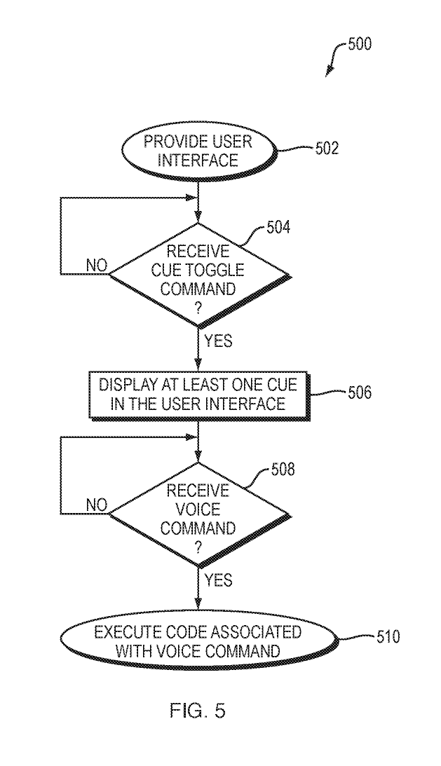

FIG. 5 is a flow diagram 500 illustrating an example embodiment of a method employed by the present invention. First, the method provides a user interface in a headset computer (502). Then, the method determines whether it has received a cue toggle command, for example, over an audio channel from a user utterance (504). If not, the method continues listening for the cue toggle command (504). If so, however, the method then displays at least one cue in the user interface (506). Each cue is associated with a corresponding voice command, which, when uttered, causes the system to execute code.

The system then determines whether it has received a voice command (e.g., a voice command shown by one of the cues) (508). If not, it keeps listening for a voice command (508). If so, however, it executes the code associated with the voice command (510).

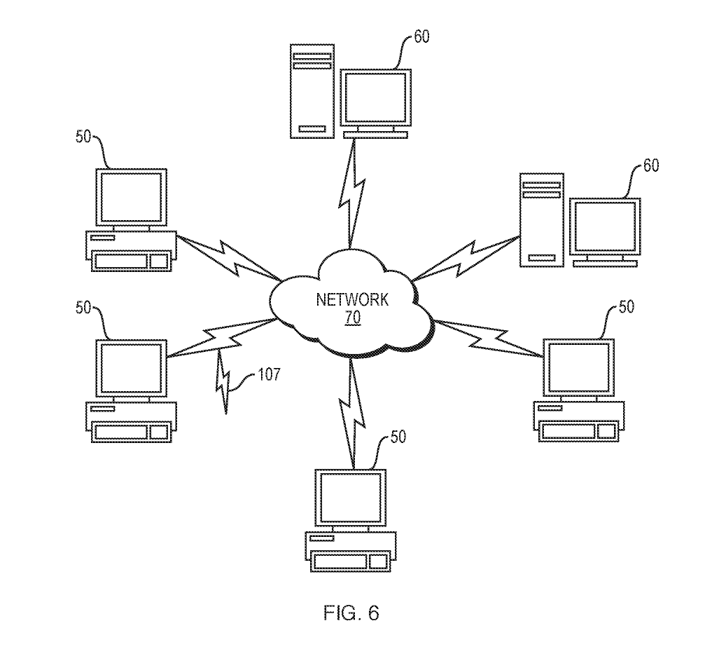

FIG. 6 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

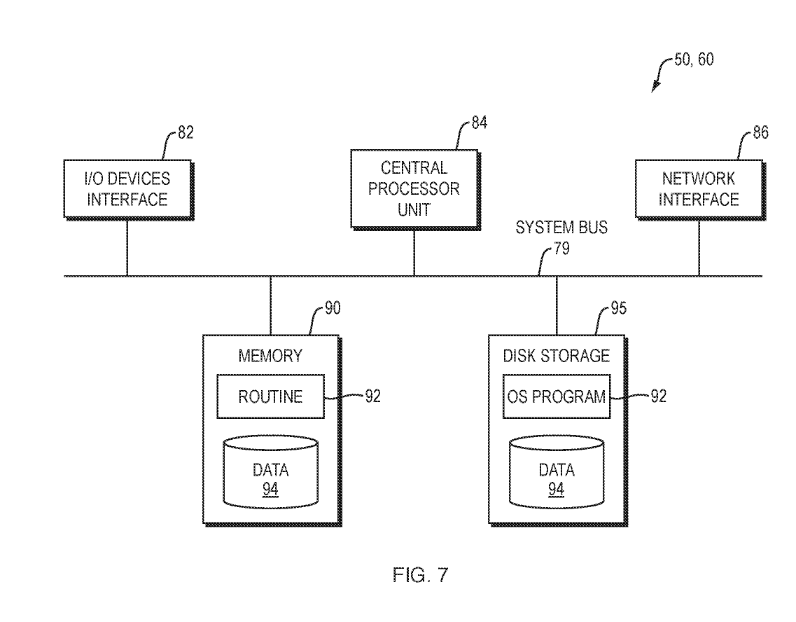

FIG. 7 is a diagram of the internal structure of a computer (e.g., client processor/device 50 or server computers 60) in the computer system of FIG. 6. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 6). Memory 90 provides volatile storage for computer software instructions 92 and data 94 used to implement an embodiment of the present invention (e.g., context sensitive overlays in a user interface code detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to example embodiments thereof, it will be understood by those skilled in the art that various changes in form and details may be made therein without departing from the scope of the invention encompassed by the appended claims.

1. A method comprising:
providing a user interface in a headset computer, the user interface having a graphical user interface portion;
in response to user utterance of a cue toggle command, displaying at least one cue within a semi-transparent overlay of the graphical user interface, each cue of the at least one cue corresponding to a voice command associated with code to execute; and
in response to user utterance of the voice command, executing the code associated with the voice command.

2. The method of claim 1, further comprising:
displaying the graphical user interface without the at least one cue prior to the user utterance of the cue toggle command and after a subsequent user utterance of the cue toggle command.

3. The method of claim 1, wherein displaying the at least one cue includes displaying words that activate the voice command.

4. The method of claim 1, further comprising associating the voice command with a control, the control displayed in the graphical user interface.

5. The method of claim 1, further comprising associating the voice command with a control, the control hidden from display in the graphical user interface.

6. The method of claim 1, further comprising associating the voice command with a control, the control being a global headset control.

7. The method of claim 1, further comprising loading the at least one cue from a control, the control indicating the at least one cue and corresponding voice command.

8. The method of claim 1, wherein the cue toggle command is available at all times and wherein the semi-transparent overlay is configured to fade away after a period of time via a timing mechanism employed to refresh a screen view of the graphical user interface.

9. The method of claim 1, wherein the at least one cue includes a plurality of cues and the method further comprises displaying the plurality of cues in order of relevance determined from context of content being displayed in the graphical user interface, a most relevant cue of the plurality of cues given more prominence in terms of placement over less relevant cues of the plurality of cues.

10. A system for displaying a user interface in a headset computer, the system comprising:
a headset computer display element with a user interface, the user interface having a graphical user interface portion, the headset computer display element configured to:
in response to user utterance of a cue toggle command, display at least one cue within a semi-transparent overlay of the graphical user interface, each cue of the at least one cue corresponding to a voice command associated with code to execute; and
in response to user utterance of the voice command, execute code associated with the voice command.

11. The system of claim 10, wherein the headset computer display element is further configured to display the graphical user interface without the at least one cue prior to the user utterance of the cue toggle command and after a subsequent user utterance of the cue toggle command.

12. The system of claim 10, wherein the headset computer display element is further configured to display words in the graphical user interface that activate the voice command.

13. The system of claim 10, wherein the voice command is associated with a control, the control displayed in the graphical user interface.

14. The system of claim 10, wherein the voice command is associated with a control, the control hidden from display in the graphical user interface.

15. The system of claim 10, wherein the voice command is associated with a control, the control being a global headset control.

16. The system of claim 10, wherein the at least one cue is loaded from a control, the control indicating the at least one cue and corresponding voice command.

17. The system of claim 10, wherein the cue toggle command is available at all times and wherein the semi-transparent overlay is configured to fade away after a period of time via a timing mechanism employed to refresh a screen view of the graphical user interface.

18. The system of claim 10, wherein the at least one cue includes a plurality of cues and the headset computer display element is further configured to display the plurality of cues in order of relevance determined from context of content being displayed in the graphical user interface, a most relevant cue of the plurality of cues given more prominence in terms of placement over less relevant cues of the plurality of cues.

19. A method of developing a user interface in a headset computer, the method comprising:
embedding a cue and a voice command in a control for a graphical user interface, the voice command associated with the control, the cue corresponding to the voice command; and
providing the control to the graphical user interface, the graphical user interface configured to display the cue within a semi-transparent overlay of the graphical user interface, responsive to user utterance of a cue toggle command.

20. The method of claim 19, wherein the cue includes words that activate the voice command.

21. The method of claim 19, further comprising displaying the control in the graphical user interface.

22. The method of claim 19, further comprising hiding the control from display in the graphical user interface.

23. The method of claim 19, wherein the control is a global headset control.

24. The method of claim 19, further comprising loading the cue from a control, the control indicating the cue and voice command.

25. The method of claim 19, wherein the cue toggle command is available at all times and wherein the semi-transparent overlay is configured to fade away after a period of time via a timing mechanism employed to refresh a screen view of the graphical user interface.

26. The method of claim 19, wherein the method further comprises displaying a plurality of cues in order of relevance determined from context of content being displayed in the graphical user interface, a most relevant cue of the plurality of cues given more prominence in terms of placement over less relevant cues of the plurality of cues.
